(19) United States
(12) Patent Application Publication
(10) Pub. No.: US 2002/0154167 A1
(43) Pub. Date: Oct. 24, 2002

(54) Displaying Web Site Icons that are collected, saved and provided by Registering Agents to Internet users as Hot-Links to a Registrant's Web Site for which the Web Site Icon represents, and which can be to used display Internet Navigational Tools' results and/or data

(76) Inventors: Walter Cox Parsons III, Merritt Island, FL (US); John Gregory Jansen, Titusville, FL (US)

Correspondence Address: BRACEWELL & PATTERSON LLP, INTELLECTUAL PROPERTY LAW, P.O. BOX 969, AUSTIN, TX, 78767-0969, US

(21) Appl. No.: 09/915,639

(22) Filed: Jul. 26, 2001

Related U.S. Application Data
(60) Provisional application No. 60/220,888, filed on Jul. 26, 2000.

(51) Int. Cl. G09G 5/00

(52) U.S. Cl. 345/764

(57) ABSTRACT

Surprisingly, the current main method for registering on the Internet (via Registering Agents) and the current main methods for navigating the Internet (Search Engines and Bookmark Lists) are textually based, rather than graphically represented and conically Hot-Linked. The use of icons prevails throughout the Internet currently, with the exception of information which is collected by Registering Agents (RA's), and which is retrieved through Search Engines (SE's) or stored in Bookmark Lists (BL's). Using Logos, in general, is the manner and process which improves the use of Internet Navigational Tools (INT's), whereby Registrants provide, and Registering Agents (RA's) compile, Hot-Linked Web Site Icons (i.e., Logos, as defined herein), which are subsequently displayed by INT's, such that Internet users can use them to improve their navigation of the Internet.

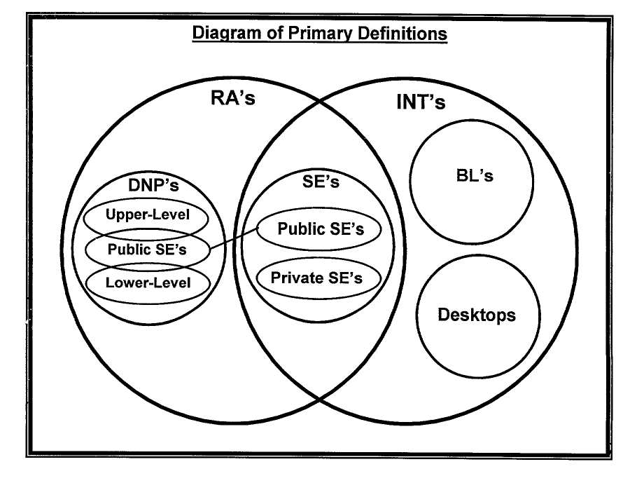

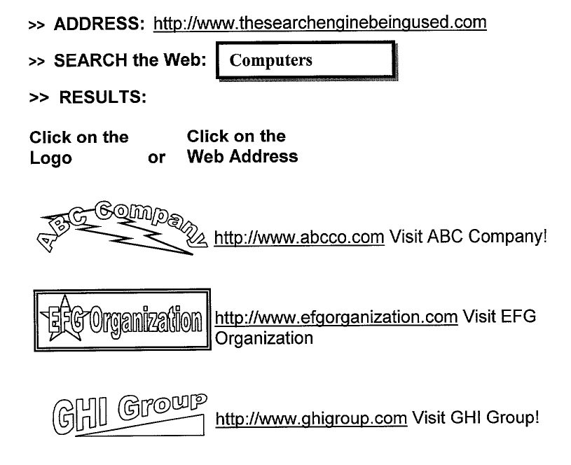

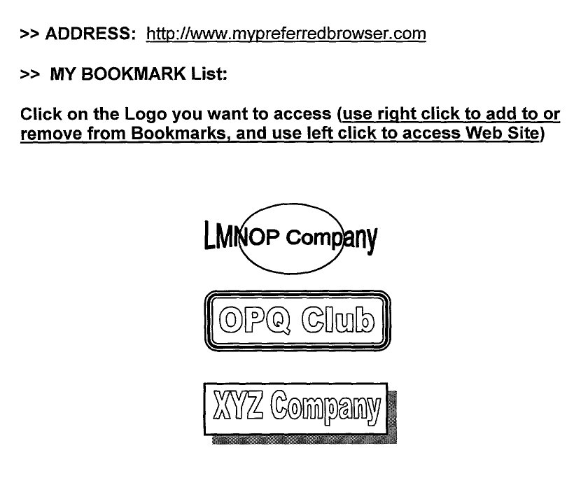

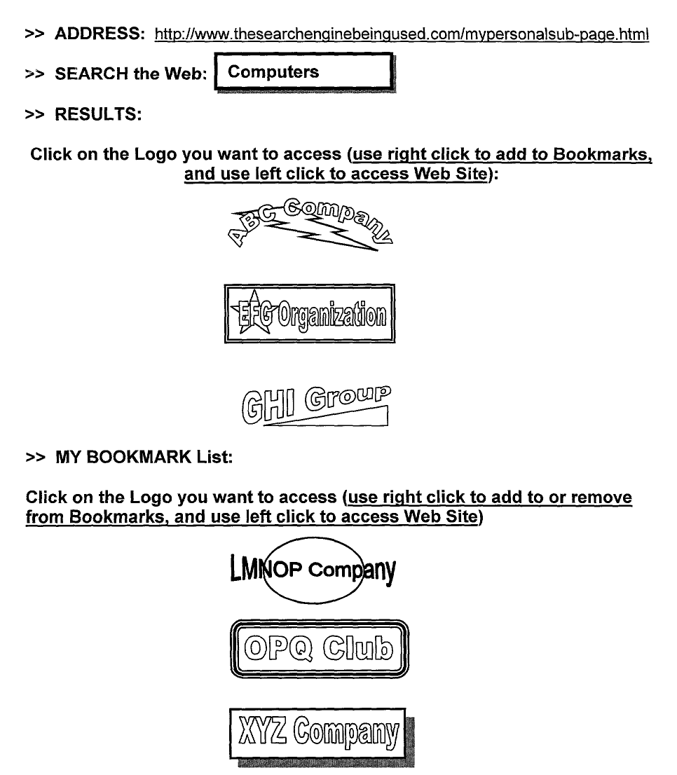

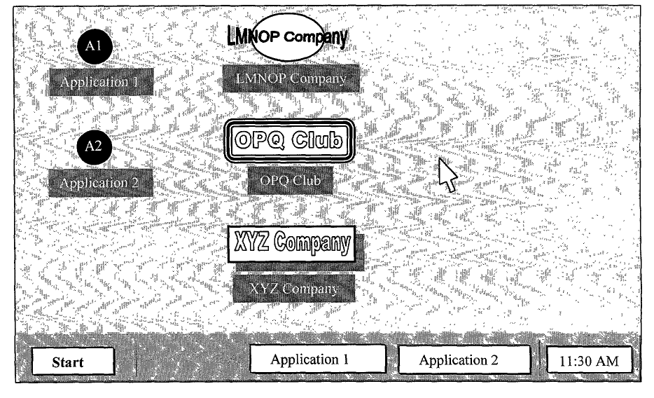

### 1) TITLE OF INVENTION

a) The title of this invention is: “Displaying Web Site Icons that are collected, saved and provided by Registering Agents to Internet users as Hot-Links to a Registrant's Web Site for which the Web Site Icon represents, and which can be used to display Internet Navigational Tools' results and/or data”

b) The co-owners, in equal shares, of this invention are:

i) Walter Cox Parsons, III United States Citizen 340 Island Beach Boulevard Merrift Island, Fla. 32952

ii) John Gregory Jansen United States Citizen 2650 Mangrum Place Titusville, Fla. 32780

### 2) CROSS-REFERENCE TO RELATED APPLICATIONS Not Applicable

### 3) STATEMENT REGARDING FEDERALLY SPONSORED RESEARCH OR DEVELOPMENT

Not Applicable

### 4) REFERENCE TO A MICROFICHE APPENDIX

Not Applicable

### 5) BACKGROUND OF THE INVENTION

a) Primary Definitions—A graphical representation of Primary Definitions is shown in Drawing 1-5.

i) “Registering Agents” (RA's) assign Domain Names to Web Sites and/or compile information about Web Sites. Information about Web Sites includes, but is not limited to, the Registrant's contact information, or the product or service promoted via the Web Site.

ii) “Domain Name Providers” (DNP's) assign Domain Names and/or collect other information about Web Sites. DNP's are specific forms of RA's. Some DNP's may also have Search Engine (SE) capabilities, and as such, they would then be operating in that capacity as a Public SE.

DNP's can be “Top-Level” or “Lower-Level”. For example, Top-Level

DNP's are under contract with governmental authorities to assign Top-Level Domain Names on a standardized basis. Registrants usually pay a small fee to the Registering Agent, typically on an annual basis, for the rights to publish a Web Site using any “.com”, “org”, “.net”, “.edu”, etc., that may be currently available. Lower-Level DNP's assign Lower-Level Domain Names by allowing a Registrant to publish a Web Site by using a sub-page under a currently registered Top-Level or Lower-Level Domain Name. Arrangements are typically made between the Registrant and the Lower-Level DNP to secure the right to use the Lower-Level Domain Name. For example, a Registrant either pays a small fee to the Lower-Level DNP for the use of the Lower-Level Domain Name, or the Registrant is given free rights to use the Lower-Level Domain Name in return for agreeing to promote Internet traffic to another Web Site.

iii) “Search Engines” (SE's) provide Internet access to databases of information about Web Sites that have been registered with the SE. SE's are specific forms of RA's as well as specific forms of Internet Navigational Tools (INT's). SE's return results after Internet users enter a variety of search criteria. For example, if an Internet user entered the term “Computer Companies” in an SE input field, the SE would search its database of information for the key words “Computer” and “Companies”, and would return to the Internet user a listing of all registered Web Sites that have these key words associated with them.

SE's can be “Public” or “Private” (not to be construed in the sense of SE's being listed on securities exchanges). A Public SE is designed to invite anyone to suggest a Web Site for inclusion in the database. After review of the proposed Web Site, it is categorized appropriately by the internal management staff of the Public SE, and subject to their final determination, the Web Site is made available to SE users for search results. A Private SE is designed to list only specific types of Web Sites in the database. With a Private SE, most often, maintenance of the database is restricted to the decisions and suggestions of the internal management staff of the Private SE. While suggested Web Sites may be solicited from the public at-large, Private SE's typically don't operate in this manner, and simply maintain their database of Web Sites in accordance with the objectives of the Private SE. For example, there are many commonly used Private SE's that provide information about manufacturers of goods. Users enter specific information about the product in which they are interested, and the Private SE returns a listing of manufacturers' Web Sites that match the specified criteria.

iv) “Bookmark Lists” (BL's) are listings of preferred Web Site Domain Names, and are managed by individual Internet users, such that each BL is specifically tailored to each Internet user's unique interests. BL's are specific forms of INT's. BL's can be managed using stand-alone software, but most often they are incorporated within the software of a Browser. Users can customize a list of Web Sites that are of specific interest and/or routine use. Entries to BL's can be added, removed, or changed with ease. Users can maintain their BL's either manually, or from the results generated by using SE's.

v) “Internet Navigational Tools” (INT's) refers to all of the methods by which Internet users access the Internet, including but not limited to, using Browsers, personal Web Sites, commercial Web Sites, and/or other software to 1) view results from SE searches, view the information contained in BL's, and/or view Desktops, and 2) to access corresponding Web Sites therefrom. Logos, if used in conjunction with INT's, will enhance the ability for Internet users to navigate the Internet.

b) Other Definitions.

i) “Browser” is a computer program that allows Internet users to navigate the Internet.

ii) “Desktop” is the top-level computer display shown upon the start-up of industry standard operating systems, and which typically includes iconical representations of application software which is available to be invoked on the user's computer. Desktops with Logos displayed thereon, are INT's.

iii) “Domain Name” refers to a unique string of characters used to name Web Sites on the Internet. Domain Names are organized hierarchically beginning with the most specific parts, followed by more generic parts.

Domain Names can be “Top-Level” or “Lower-Level”. Top-Level Domain Names are at the highest level of the Internet hierarchy, and Lower-Level Domain Names are at all but the highest level of the Internet hierarchy. For example, a Top-Level Domain Name for the Company X could be “companyx.com” and a Lower-Level Domain Name for Company X's product information could be “companyx.com/sales/products.html”.

iv) “Hot-Link” refers to the Internet navigational capability to select an image and/or word(s) displayed by a computer such that the selection directs the computer to invoke a Browser to display an Internet Web Site.

v) “Internet” is the worldwide networking of computers using network protocols to facilitate data transmission and exchange.

vi) “Registrant” is an entity that registers a Web Site with an RA.

vii) “Tags” include key words and/or Web Site Icons that are presented as being representative of a Web Site's content by their inclusion, and labeling as such, in the Web Site's computer source code. An example of Tags are the “meta tags” used in Hyper-Text Markup Language (HTML), which is one example of an industry standard Web Site publishing language of the Internet.

viii) “Logo” is a Web Site Icon that 1) is submitted by a Registrant to an RA, 2) has an audio and/or visual image format which is predominantly, if not completely, determined by the Registrant, notwithstanding standardization of registration methodology as may be established by the RA to which it was submitted, 3) is subject to be changed upon the request of the Registrant, 4) is collected, saved, and provided by the RA to Internet users as a Hot-Link to the Registrant's corresponding Web Site for which the Web Site Icon represents, and 5) can be used by INT's to display an INT's results and/or data.

ix) “Web Site” is one or more pages of information which are available to be accessed using the Internet.

x) “Web Site Icon” is a graphical representation of a Registrant, such as a company logo or an image related to the product or service promoted by the Registrant's Web Site. A Web Site Icon can be animated and/or static.

Furthermore, a Web Site Icon can have audio and/or video associated with it.

c) The Change From Text-Based To Visual-Based Operating Systems.

In recent years, the Internet has become used more profusely than ever, and indications are that this trend will continue in geometric proportions. When personal computing began to take hold, people used a text-based operating system to run a computer. Since then, a better, more user-friendly way was developed to enhance and operate upon the text-based operating system platform. Now, the current industry standard visual/icon-driven operating system software, in its most current revision, is the most technologically advanced and widely used personal computer operating system. The current technology is far more iconically based than is its textual predecessor. This, coupled with application software such as word processors and spreadsheet programs that operate in the current more user-friendly environment, gives users unprecedented ease and confidence in using a personal computer today in comparison to when personal computing began.

d) The Use of Icons in Current Technology.

The key to the success of the current industry standard visual/icon-driven operating system software, and corresponding application software that runs in such an environment, is its “iconical” format, which lends itself to user friendliness. Icons are symbols used to represent various functions that a user can perform with whatever application software that is in use. The use of icons facilitates the efficient and effective use of the software. The iconical format used in conjunction with the point-and-select capability of the common computer mouse, light pen, or touch-screen, provides ease and simplicity in operating software. For instance, using a mouse to point and click on the “thumb-nail” size image of a computer printer will pop-up the printer sub-window from which the user can ultimately click on further selections to print a document to the user's specifications.

e) Reasons for Using Icons.

The visual nature of current industry standard operating system platforms and software applications are representative of both the human nature of our society and the increasing globalization that the use of the Internet continues to promote.

Human nature is to find the easiest way to perform tasks. Icons speed the process of using software, and increase our efficiency and effectiveness. For individuals, this provides more free time for family and leisure activities by maximizing the use of the computer, and specifically the Internet, for personal and recreational activities. For businesses, this correlates to increased efficiency of employees who use computers, and specifically the Internet, in the work environment, and increased profitability in the marketplace since customers relate quickly and instantly to a visual image of a company in comparison to a verbal or written statement of the same information.

As the world “globalizes” across borders, language barriers may become increasingly present. Despite the fact that there is just a handful of dominating languages, the fact remains that they are indeed separate languages. While words differ among languages, visual representations do not. For instance, an iconical image of a printer looks the same to each and every English, Spanish, French, Russian, or Japanese speaking person. Thus, the use and selection of an iconical-based system crosses all borders.

f) Summary of Shortcomings, Disadvantages, and Problems With Existing Technology.

i) RA's collect only textual information about their Registrants, despite the fact that for other promotional purposes, most Registrants use a graphical representation of their product or service, such as a company logo.

ii) Iconical Web Site Hot-Links are not being displayed by INT's, despite the fact that they will improve Internet users' ease and confidence in using a personal computer and in navigating the Internet.

iii) Textual information which is currently collected by RA's and displayed by INT's is not as user-friendly for Internet users, nor is it as readily recognizable, as is iconical information.

iv) Textual information which is currently displayed by INT's is not as readily recognizable as iconical information, which impedes the efficiency and effectiveness of personal and professional Internet users, resulting in correspondingly less leisure time and reduced profits.

v) Textual information that is currently displayed by INT's maintains language barriers, despite the Internet being an internationally used tool.

vi) The primary method by which Internet users navigate the Internet is with information displayed by INT's. Although INT's are generally designed to operate in the user-friendly iconical environment of current industry standard operating systems and software applications, it is ironic to note that these primary methods for using the Internet are not iconically based.

g) Relevant Prior Art Patents and Reasons Why They Don't Solve the Shortcomings, Disadvantages, and Problems with Existing Technology.

i) An extensive patent search has produced no results that are specifically relevant to the use of Logos, nor do existing patents achieve the objectives reached by implementing Logos.

ii) The existing art makes extensive use of Hot-Links. However, this is not the manner in which Logos would be implemented, since such navigation is not based on user-specific search input criteria, nor are results using Web Site Icons specific to a given Registrant.

iii) Some existing art does provide search results in an iconical format, but the results only return one of a handful of pre-set icons, none of which were submitted, determined, or subject to be changed by Registrants. While this type of art typically provides search results in a graphical format, the intention is to simply arrange search results in a variety of manners, such as the size or location of the image versus its relevancy, or the presentation of a generic icon for a given category.

iv) The term “image” is used profusely in existing art, but it is not defined to be a Hot-Linked Web Site Icon. The general intent of existing art is not what the image is, but rather, how big is the image and where is the image placed on the screen.

v) The existing art for SE's, and for RA's in general, permit Registrants to register only textual information, which would be provided to users who perform a search. While the textual information is Hot-Linked, Web Site Icons are not.

vi) The existing art does not discuss the collection by RA's of Logo information, the maintenance thereof by RA's and Registrants, or the display of Logos as they apply to SE's, BL's, and Desktops.

vii) The existing art does not discuss the objective of improving Internet navigation by using Logos.

h) Objectives of the Invention in Meeting or Solving the Shortcomings, Disadvantages, and Problems of Existing Technology. The objectives of the Invention are:

i) To have RA's collect and compile Logos.

ii) To have INT's display results in Logo format, as collected and compiled by RA's,:

(1) To improve Internet users' ease and confidence in using a personal computer and in navigating the Internet.

(2) To promote more user-friendliness for Internet users, and greater recognizability of INT results.

(3) To improve the efficiency and effectiveness of personal and professional Internet users, resulting in correspondingly greater leisure time and increased profits.

(4) To eliminate language barriers, since the Internet is an internationally used tool.

iii) To replace the existing INT's verbiage-based Internet navigation methodology with Logos, which is an iconically based Internet navigation methodology.

### 6) BRIEF SUMMARY OF THE INVENTION

Implementing Logos is the manner and process which improves the use of Internet Navigational Tools (INT's), whereby Registering Agents (RA's) compile Hot-Linked Web Site Icons (i.e., Logos), based on input from Registrants, and whereby the Logos are subsequently displayed by INT's, such that Internet users can use them to improve their navigation of the Internet.

### 7) BRIEF DESCRIPTION OF THE SEVERAL VIEWS OF THE DRAWING

a) Drawing 1-5: Diagram of Primary Definitions. This is a graphical representation of the inter-relation among RA's, INT's, SE's (both Public and Private), DNP's, BL's, and Desktops with Logos.

b) Drawing 2-5: This is an example of SE results being displayed in a combination of iconical and textual formats.

c) Drawing 3-5: This is an example of a BL being displayed in iconical-only format.

d) Drawing 4-5: This is an example of a BL, combined with an SE of the user's choice, being displayed in iconical-only format.

e) Drawing 5-5: This is an example of Logos being displayed on a Desktop.

### 8) DETAILED DESCRIPTION OF THE INVENTION

a) Manner and Process of Making the Invention.

i) Obtaining a Domain Name for a Web Site.

For a Web Site to exist on the Internet, it must have a Domain Name. While Top-Level DNP's are able to assign Top-Level Domain Names, there are other methods for obtaining a Domain Name. For example, if a Registrant is not interested in obtaining a Top-Level Domain Name for a Web Site, a Domain Name can still be established by obtaining a Lower-Level Domain Name from a Lower-Level DNP, which will allow a Registrant to publish a Web Site using a sub-page under a currently registered Top-Level or Lower-Level Domain Name. When a Domain Name is established for the Web Site, then can it be submitted to an RA with SE capabilities.

ii) Submitting a Web Site Icon and Domain Name Information to an RA for Registering a Logo.

When registering a Web Site with an RA, the Registrant is asked a series of questions whereby the RA gathers sufficient information to list the Registrant's Web Site among other Registrants' Web Sites that have been previously accepted by the RA. Most often this process is accomplished electronically over the Internet, and e-mail attachments have paved the way for the ease in requesting and collecting this information, including Web Site Icons. To begin the Logo process, the first question would simply be to the effect of “Attach an electronic version of your Web Site Icon here:” and the Registrant would do so. The second question would simply be to the effect of “To which Domain Name do you want to Hot-Link the Web Site Icon? (the default is the Web Site for which you are registering)” and the Registrant either answers the question or accepts the default Hot-Link. Even if registration is accomplished by customary mail delivery, one floppy disk which contains the electronic file of the Web Site Icon, accompanied by written direction as to which Web Site to use as a Hot-Link, could be sent with the registration package.

iii) Creating the Logo.

Once the Web Site Icon is obtained by the RA from the Registrant, it is a simple matter of using widely available industry-standard Web Site publishing software to Hot-Link the Web Site Icon to the Domain Name, and to store the Logo in the RA's database. Hot-Linking can easily be automated by the RA using computer programming which can be incorporated into the RA's registration software.

iv) Using Tags to Identify Web Site Icons.

During the registration process, most RA's with SE capabilities (RA/SE's) permit Registrants to designate key words that are indicative of the Web Site content. These key words are retained in the RA/SE's database and are used for matching to search requests. Most often, these are the same or similar key words that are included within the Web Site's Tags.

Some registration processes for RA/SE's are computer-driven and some are human-driven. The difference is primarily whether the RA/SE's computer “crawls through” the Web Site, or whether a representative of the RA/SE actually browses the proposed Web Site. Whether automated or manual, information is obtained about the Web Site, including the information in the Web Site's Tags, all of which can be stored in the RA/SE's database for future searches.

If the Web Site Icon is included in the Web Site's Tags, then it can be used by the RA/SE's to be Hot-Linked to the Web Site in which the Web Site Icon is located. Therefore, when a Web Site is registered with RA/SE's, the RA/SE's will easily know what to use to create the Logo.

Similarly, when adding a Web Site to a BL, this technique of using Tags would be used to again identify the Web Site Icon to be the Logo on the BL display.

v) Current Registrants.

Web Sites that are currently registered with RA's, more than likely have not provided information either during the registration process or within the Web Site's Tags, whereby a Web Site Icon is specifically identified. However, as part of the registration process, the RA's have compiled contact information within their databases, which typically includes an e-mail address of the Registrant. Using this information, a “registration update” request can quickly and easily be sent to notify the Registrant of the RA's Logo database service. The Registrant would simply reply to the e-mail with an attached file or an inserted graphical image of the Web Site Icon to be used as the Logo, in addition to the Domain Name to which the Web Site Icon would be Hot-Linked. Alternatively, the RA could offer the Registrant the option to indicate that the Web Site Icon is included within the HTML coding of the Web Site, or to manually submit the requested information.

vi) New Registrants.

As part of the registration process for new Web Sites, RA's will request each Registrant to provide the Web Site Icon that the Registrant wishes to have displayed as the Logo, in addition to the Domain Name to which the Web Site Icon would be Hot-Linked. This can be accomplished by implementing only a minor modification to the on-line or manual registration forms that are currently used by RA's, such that the additional information can be requested by RA's and subsequently provided by Registrants.

vii) Updating RA's Logo Databases.

(1) RA's Performing Updates to Their Logo Databases.

If included within the Web Site's Tags, as Registrants update their Web Site Icons, RA's can routinely refresh their Logo databases with automated or manual searches of Web Sites. Otherwise, RA's can perform updates in the same fashion as the “registration update” for current Registrants, as described earlier.

(2) Registrants Updating Web Site Icon and Domain Name Information as Previously Submitted to an RA.

As described earlier, Registrants submit Logo information (i.e., the Web Site Icon and the corresponding Domain Name to use as the Hot-Link) during registration with each RA and Registrants must subsequently maintain each registration as updated. In fact, this is the current methodology employed for textually registering Web Sites. However, if this becomes too burdensome for a Registrant because of multiple RA registrations, for instance, companies currently exist that can administer the registration and update process on behalf of the Registrant.

b) Manner and Process of Using the Invention.

i) Publicizing a Web Site by Registering with SE's.

Obtaining a Domain Name and publishing a Web Site, does not publicize it to the world—it only provides the world access to the Web Site. If Internet users are unaware of the Web Site, they will not traffic to it, except by incident or by accident. To “tell the world” about a Web Site, a Registrant must register the Web Site with at least one RA that has SE capabilities. Actually, this does not “tell the world” about the Web Site, it only “tells the SE users” about the Web Site. This is why registration with multiple SE's, for instance, provides maximum exposure for a Web Site by increasing the likelihood of Internet traffic to the Web Site, as each SE provides results to its users based upon the search criteria entered.

ii) Using Logos in SE's.

SE's that have created a Logo database, and SE's with access to an RA's Logo database can make effective use of these iconical representations of Hot-Linked Web Sites. Upon accessing the SE's main search page, users can enter their search criteria and then click on the button most suited to their preferences to display the search results: “Logo and Text” or “Logo Only” or “Text Only”. For reasons described earlier, and as the speed of Internet access is continually increasing, most users would select one of the first two options. Eventually, the “Text Only” option may be dropped as Internet graphic image load-times decrease because of quicker Internet response times from improved telecommunications equipment and computer hardware. Especially since the Logo is anticipated to be displayed as a relatively small, “thumb-nail” sized icon, the load-time is negligible with most users' current equipment.

When the results of the SE search are displayed, users can “mouse-over” the Logo (and/or the textual hot-link, if the “Logo and Text” search option was chosen), and by, for instance, left-clicking on the Logo, the Browser will route the Internet user to the selected Web Site.

An example of SE results, being displayed in a combination of iconical and textual format, is shown in Drawing 2-5.

iii) Using Logos in BL's.

With SE results, users can set-up their BL's to display as “Logo and Text” or “Logo Only” or “Text Only”, depending on user preferences. Again, since the Logo is anticipated to be displayed as a relatively small, “thumb-nail” sized icon, the load-time is negligible with most users' current equipment.

BL's can be managed using stand-alone software, but most often they are incorporated within the software of a Browser. A simple modification to the software will permit the user to make use of Logos:

(1) based upon the SE's display of Logos from search results. In this scenario, users would be able to update their BL's using Logos obtained directly from the resulting search pages displayed by SE's. Users would “mouse-over” and, for instance, right-click on a Logo to access a pop-up menu from which a selection could be made to add the Logo to the BL.

(2) while the Internet user is browsing a specific Web Page. In this scenario, the concept of including the Web Site Icon within the Web Site's Tags would be used to again identify the Web Site Icon to be Hot-Linked to the Web Site in which the Web Site Icon is located, such that it can be displayed as a Logo on the user's BL. Users would “mouse-over” and, for instance, left-click on an “Add this Web Site's Logo to My Bookmark List” button on the Browser or BL software's toolbar.

When the user's BL is displayed, users can “mouse-over” the Logo (and/or the textual hot-link, if the “Logo and Text” search option was chosen), and when the user, for instance, “double-left-clicks” on the Logo, it will automatically invoke a Browser and navigate the Internet user to the Logo's Hot-Linked Web Site.

Updating BL's would not change from the present-day, as links would be added or deleted at the user's will.

An example of a BL, being displayed in iconical-only format, is shown in Drawing 3-5.

iv) Using Logos in a Combined SE-BL.

If an SE of the user's choice is a Lower-Level DNP, then a user's BL can be combined with the SE's capabilities into a Web Site subpage at any level under the SE's Domain Name, to create a personalized SE/BL for the user.

An example of a BL, combined with an SE of the user's choice, being displayed in iconical-only format, is shown in Drawing 4-5.

v) Using Logos on a Desktop.

Users can make use of Logos on their Desktops:

(1) based upon the SE's display of Logos from search results.

In this scenario, users would be able to modify their Desktops using Logos obtained directly from the resulting search pages displayed by SE's. Users could “mouse-over” and, for instance, right-click on a Logo to access a pop-up menu from which a selection could be made to add the Logo to the users Desktop. Alternatively, the user could “mouse-over” and, for instance, “click and drag” the Logo directly to the user's Desktop.

(2) while the Internet user is browsing a specific Web Page.

In this scenario, the concept of including the Web Site Icon within the Web Site's Tags would be used to again identify the Web Site Icon to be Hot-Linked to the Web Site in which the Web Site Icon is located, such that it can be displayed as a Logo on the user's Desktop. Users would “mouse-over” and, for instance, left-click on an “Add this Web Site's Logo to My Desktop” button on the Browser's toolbar.

(3) while the user's BL is displayed.

When the user's BL is displayed, users can “mouse-over” the Logo and, for instance, right-click on a Logo to access a pop-up menu from which a selection could be made to add the Logo to the users Desktop. Alternatively, the user could “mouse-over” and, for instance, “click and drag” the Logo directly to the user's Desktop.

Once on the user's Desktop, the Logo would automatically be displayed upon each “boot-up” of the user's computer, such that if the user, for instance, “double-left-clicks” a Logo on the Desktop, it will automatically invoke a Browser and navigate the Internet user to the Logo's Hot-Linked Web Site.

Updating Desktops would not change from the present-day, as the display could be changed at the user's will.

An example of Logos being displayed on a Desktop is shown in Drawing 5-5.

vi) Using Shared and Unshared Logo Databases.

If only one RA creates a Logo database, then that RA can serve as a central database. The RA could permit SE's access to, and usage of, the Logo database, and, in this event, a shared Logo database is created.

If multiple RA's create Logo databases, then each RA could share with other RA's, as well as permit SE's access to, and usage of, the Logo databases. In this event, shared Logo databases are created. However, as a result of Registrants registering with RA's that share their Logo databases, there is a potential for inconsistencies in displaying a current and/or accurate Logo, in the event the Registrant provided each RA with a different Web Site Icon and/or Domain Name to be used as a Hot-Link for the Web Site. However, this situation can easily be reconciled with a slight enhancement of the RA's database software. For instance, if the Registrant with each RA is the same, but if the Logos don't match, then one Logo could supersede the other Logo based upon the date and time upon which the Registrant submitted the most recent information.

Unshared Logo databases could exist as each RA with SE capabilities creates, and solely draws upon its own such database. In this event, Registrants must submit Logo information during registration with each RA, and Registrants must subsequently maintain each registration as updated. In fact, this is the current methodology employed for registering Web Sites with most SE's, but if this becomes too burdensome for a Registrant, companies currently exist that can administer the registration and update process on behalf of the Registrant.

Alternatively, any combination of shared and unshared Logo databases could exist, in accordance with each RA's objectives.

c) “Best Mode” for Implementing the Invention.

i) All RA's will electronically collect, during the on-line registration process, a Web Site Icon from each of their current and new Registrants, in addition to the Domain Name to which the Web Site Icon would be Hot-Linked. Alternatively, the RA could offer the Registrant the option to indicate that the Web Site Icon is included within the Web Site's Tags to be Hot-Linked to the Web Site in which the Web Site Icon is located, or to manually submit the requested information.

ii) If included within the Web Site's Tags, as Registrants update their Web Site Icons, their Web Site's Tags should be updated to reflect the updated Web Site Icon. RA's can routinely refresh their databases with automated or manual searches of Web Sites. Otherwise, updates can be performed in the same fashion as was used to initially collect the information from the Registrants.

iii) Once the Web Site Icon is obtained by the RA, it is a simple matter of using widely available industry-standard Web Site publishing software to Hot-Link the image to the Domain Name, and to store the Logo in the RA's database. Hot-Linking can easily be automated by the RA using computer programming which can be incorporated into the RA's registration software. In the event Registrants submit Web Site Icons that have already been Hot-Linked by the Registrant, the RA's Hot-Linking procedure will be duplicative, but this will not impede the objective of creating the Logo database.

iv) RA's will have the option to make their Logo database available for INT's to draw upon, and/or if the RA has SE capabilities, it will use its Logo database for providing responses to search requests made by Internet users.

v) When an SE, with access to its own or another RA's Logo database, displays the results of a search, Internet users can “mouse-over” the Logo, and by, for instance, left-clicking on the Logo, the Browser will route the Internet user to the selected Web Site.

vi) BL's can be managed using stand-alone software, but most often they are incorporated within the software of a Browser. A simple modification to the software will permit the Internet user to make use of Logos 1) based upon the SE's display of Logos from search results, and 2) while the Internet user is browsing a specific Web Page.

vii) Desktops can be managed by Internet users to make use of Logos 1) based upon the SE's display of Logos from search results, 2) while the Internet user is browsing a specific Web Page, and 3) while the Internet user's BL is displayed.

We claim that:

1. Implementing the Logo concept will provide a new product to Registrants for promoting their Web Sites.

2. Implementing the Logo concept will enhance and improve all aspects of browsing the Internet by combining the use of Hot-Linked Web Site Icons with the capabilities of RA's/INT's.

3. Implementing the Logo concept will modify the display of INT's, which are the primary methods used by Internet users to navigate the Internet, from a textual display to an iconical display.

4. Implementing the Logo concept will shift the method by which Internet navigation is performed, from a textual Domain Name selection to an iconical Domain Name selection.

5. Implementing the Logo concept will broaden the current industry standard of information collected by RA's, whereby the collection of such information will shift from a strictly textual format to additionally include an iconical format.

6. Implementing the Logo concept will broaden the current industry standard of information displayed by INT's, whereby the display of such information will shift from a strictly textual format to additionally include an iconical format.

7. Implementing the Logo concept will provide many new refinements to the structure and design of RA's and INT's, some of which are mentioned herein, but most of which have yet to be developed. Such refinements would not have been possible without using the Logo concept.

8. Implementing the Logo concept will benefit Internet users through more efficient and effective use of the Internet.

9. Implementing the Logo concept will benefit Registrants by improving their presence on the Internet, thereby increasing traffic to their Web Sites.

10. Implementing the Logo concept will permit iconical representation and viewing of the results generated by SE's.

11. Implementing the Logo concept will permit iconical representation and viewing of the Internet users' BL's.

12. Implementing the Logo concept will improve Internet users' navigation of the Internet by making use of Hot-Linked Web Site Icons.

13. Implementing the Logo concept will permit the development a personalized and combined SE/BL Web Page under an SE's home Web Page.

14. Implementing the Logo concept will permit Internet users' navigation to preferred Web Sites directly from the Internet users' Desktops.
